(19) United States
(12) Patent Application Publication
(10) Pub. No.: US 2019/0151689 A1
(43) Pub. Date: May 23, 2019

(54) Positive-pressure Air Respirator Carrying Tool for the Air Cylinder Holder with A Built-in Decompressor

(71) Applicant: Quan Peng, Dongtai City (CN)

(72) Inventor: Quan Peng, Dongtai City (CN)

(21) Appl. No.: 16/191,482

(22) Filed: Nov. 15, 2018

(30) Foreign Application Priority Data
Nov. 17, 2017 (CN) 201711148298.0

(51) Int. Cl. A62B 25/00; A62B 7/02; A62B 9/04

(52) U.S. Cl. CPC A62B 25/00; A62B 9/02; A62B 9/04; A62B 7/02

(57) ABSTRACT

This invention refers to a positive-pressure air respirator carrying tool for the air cylinder holder with a built-in decompressor in the technical field of backboard parts of positive-pressure air respirator. It breaks through the traditional structure that decompressor tends to be fixed with air respirator at the outside bottom of the backboard. The original design can be easily polluted, corroded, or damaged by hard objects, and there is a hard connection between decompressor and air cylinder valve. This application installing the decompressor within the air cylinder holder of the backboard makes use of the space inside air cylinder holder skillfully, with decompressor cover plate on air cylinder holder. As for the compressed air in the air cylinder, the air cylinder is connected with decompressor via soft tube. In this way, the decompressor will be protected and other functions will not be impaired so that the safety of decompressor can be assured. Meanwhile, in the presence of the high-pressure soft connecting tube, the joint of air cylinder valve can be adjusted from all angles and then connected with air cylinder valve to improve the efficiency of changing air cylinder during rescue operation.

### TECHNICAL FIELD

Falling within the technical field of backboard parts of positive-pressure air respirator, this application particularly refers to a carrying tool for compressed air respirator and positive-pressure firefighting respirator with self-contained open circuit, namely, a carrying tool for air cylinder holder with a built-in decompressor.

### TECHNICAL BACKGROUND

Positive-pressure air respirator is aimed at protecting people from harmful smoke, toxic gas, and hazardous substance in the air, or used in the oxygen-deficient environment. Current decompressors tend to be fixed outside the bottom of backboard, as shown by FIGS. 1 and 2. According to these two structural diagrams, the decompressor can be easily polluted or corroded by corrosive gas, fluid and dust or damaged by hard objects. Besides, there is a hard connection between decompressor and air cylinder valve. As a result, the connection cannot be completed quickly because of difficulties in angle adjustment, which will then impact the efficiency of changing air cylinder during rescue operation.

### CONTENTS OF INVENTION

Due to deficiencies of existing technologies, this application is aimed at proposing a positive-pressure air respirator carrying tool for the air cylinder holder with a built-in decompressor.

To resolve the technical problems above, this application offers a positive-pressure air respirator carrying tool for the air cylinder holder with a built-in decompressor, which breaks through the traditional structure that decompressor tends to be fixed with air respirator at the outside bottom of the backboard. Below are the technical schemes.

The positive-pressure air respirator carrying tool for the air cylinder holder with a built-in decompressor has a backboard main body, a decompressor and an air cylinder holder. The backboard is equipped with an air cylinder holder, which is used to fix the air cylinder, and the decompressor is installed within the air cylinder holder.

The air cylinder holder is utilized along with air cylinder belt and buckle. The air cylinder will be locked by air cylinder belt and buckle after being installed on air cylinder holder.

The backboard above has a compressed air respirator with a self-contained open circuit or high-positive fire-fighting respirator.

In this application, the decompressor is installed within the air cylinder holder at the upper part of backboard to make use of the space inside the air cylinder holder skillfully, with decompressor cover plate on the holder. As for the compressed air in the air cylinder, the air cylinder is connected with decompressor via soft tube, and then linked with the high pressure gauge and air supply valve via the two joints at the bottom of the decompressor, respectively. In this way, the decompressor will be protected and other functions will not be impaired to assure the safety of decompressor. Meanwhile, in the presence of the high-pressure soft connecting tube, the joint of air cylinder valve can be adjusted from all angles and then connected with air cylinder valve to ensure quick completion of operation steps and improve efficiency of changing air cylinder during rescue operation.

### EXPLANATIONS ON FIGURES

Detailed descriptions on non-restrictive examples are made according to figures below, which can make other features, aims and advantages of this application more clear.

FIG. 1 Structural diagram for decompressor outside backboard in existing technology (with air cylinder);

FIG. 2 Structural diagram for decompressor outside backboard in existing technology (without air cylinder);

FIG. 3 Structural diagram for backboard with decompressor inside air cylinder holder in this application;

FIG. 4 Structural diagram for backboard with air cylinder in this application;

FIG. 5 Structural diagram for backboard without decompressor in this application;

FIG. 6 Structural diagram for another direction of backboard with air cylinder in this application;

1—Backboard's main body; 2—decompressor; 3—air cylinder holder; 4—decompressor cover plate; 5—air cylinder; 6—air cylinder valve; 7—valve seat; 8—valve joint; 9—high-pressure soft tube; 10—high-pressure tube; 11—middle-pressure tube; —2′-decompressor's bracket; 12 air cylinder belt;13—air cylinder buckle

### SPECIFIC IMPLEMENTATION MODES

Detailed explanations on this application will be conducted according to examples. The examples below will help technicians in this field to understand this application better, but will not impose any constraints over this application. It is worth noticing that any changes and improvements made by ordinary technicians in this field on the premise of following the thoughts of this application shall fall within the protective scope of this application.

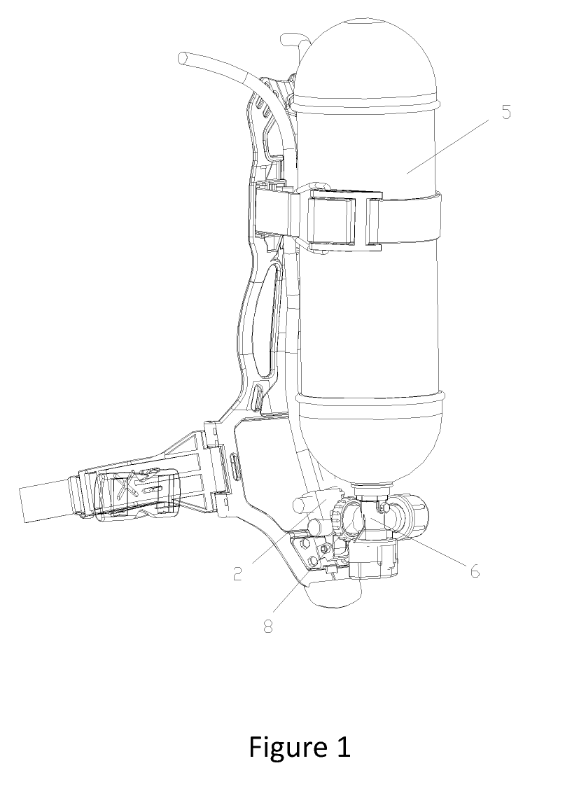

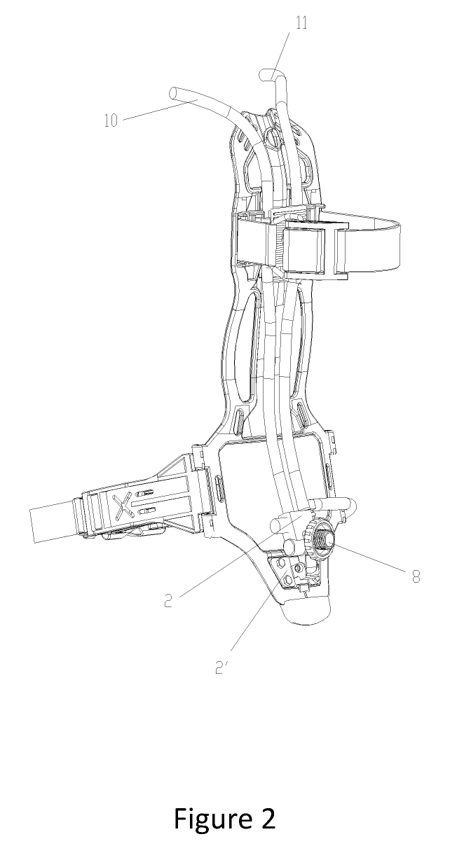

FIGS. 1 and 2 are structural diagrams for decompressor outside backboard in existing technologies. Decompressor 2 is fixed outside the bottom of backboard 1 through decompressor bracket 2′. Consequently, decompressor 2 cannot alter its angle or move in a small range freely. Because of the hard connections between decompressor 2 and valve joint 8 as well as air cylinder valve 6, valve joint cannot alter its angle or move in a small range freely to work with air cylinder valve.

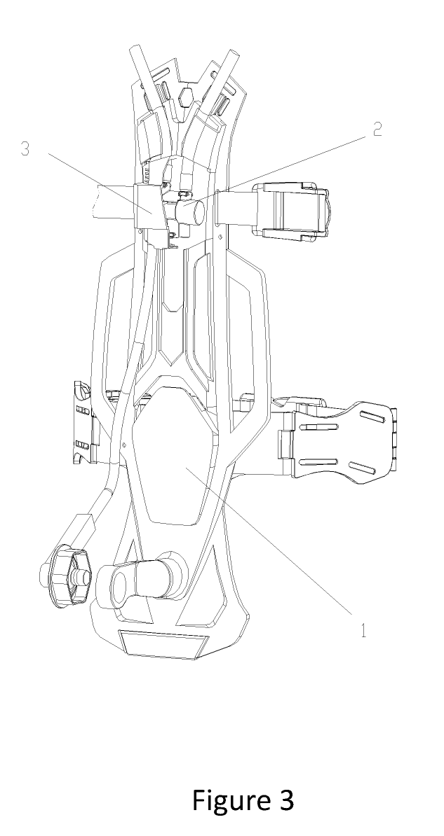

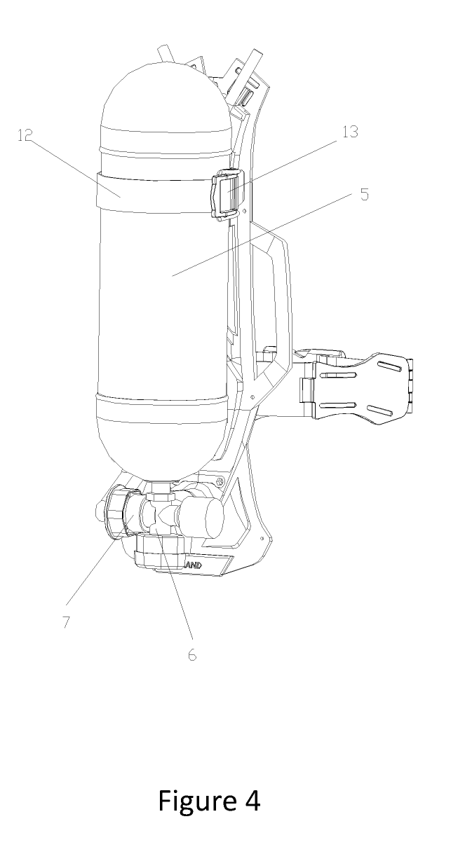

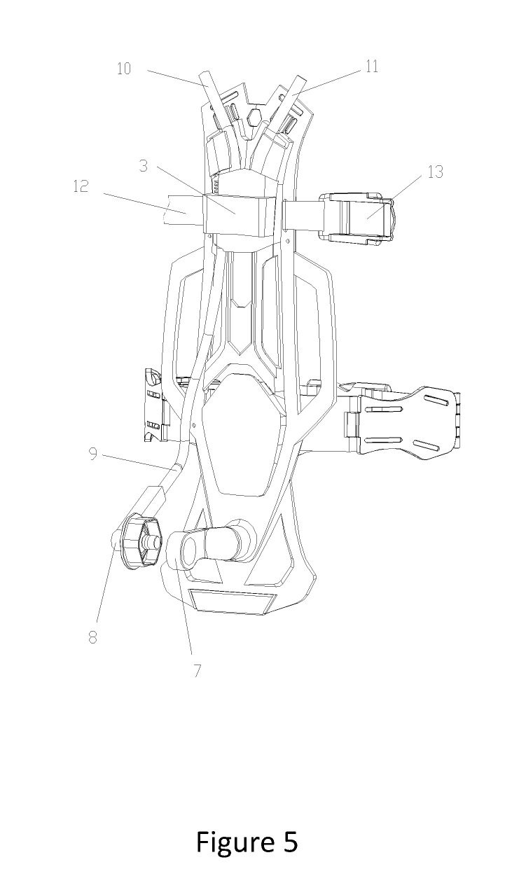

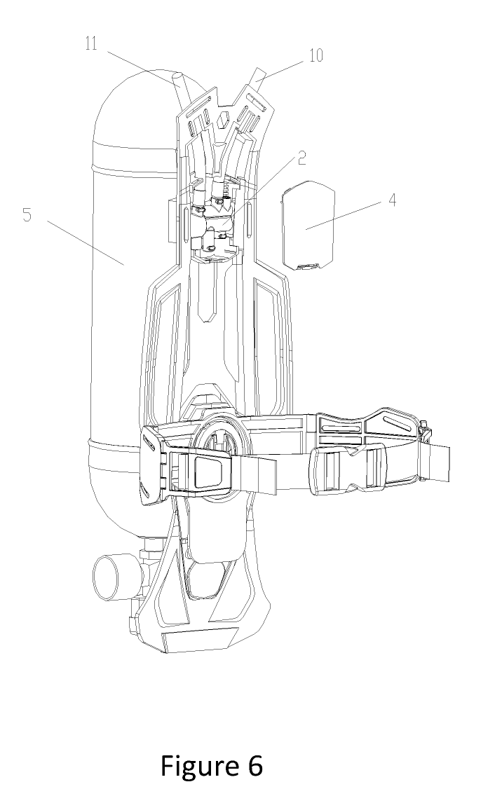

FIGS. 3-6 show the structural diagram for the backboard with decompressor inside air cylinder holder in this application. The backboard is equipped with a backboard main body 1, decompressor 2, air cylinder holder 3, and decompressor cover plate 4. The backboard's main body is equipped with an air cylinder holder 3, which is used to fix the air cylinder 5, and the decompressor 2 is installed within the air cylinder holder 3. The air cylinder holder 3 is utilized along with air cylinder belt 12 and buckle 13. The air cylinder 5 will be locked by air cylinder belt 12 and buckle 13 after being installed on air cylinder holder 3.

The decompressor cover plate 2 is designed on air cylinder holder 3, which is aimed at fixing decompressor 2.

The air cylinder holder 3 is characterized by a concave arc shape, inside which decompressor 2 is installed. As for the compressed air within air cylinder 5, the high-pressure soft tube 9 is connected with decompressor 2, and then linked to high-pressure tube and high-pressure gauge, as well as middle-pressure tube and air supply valve through two joints at the top of decompressor 2. To be specific, the backboard, air cylinder 5 including air cylinder valve 6 and high-pressure soft tube 9 are linked to decompressor 2 at one end, and with air cylinder valve joint 8 at the other end. The middle-pressure tube 11 is connected with air supply valve via coupler at one end and with decompressor 2 at the other. The high-pressure tube 10 is linked with high-pressure gauge and alarm at one end, and with decompressor at the other. In this example, air cylinder valve 6 of air cylinder 5 is linked to valve seat 7 and valve joint 8, with valve seat 7 between air cylinder valve 6 and valve joint 8. There is a slot inside the upper part of air cylinder holder 3. The upper part of decompressor cover plate 4 is inserted into the slot of air cylinder holder 3, and its lower part is fixed beneath air cylinder holder through resilient clip.

This application also refers to a self-contained open-circuit compressed air respirator or positive-pressure firefighting air respirator for carrying tool with decompressor inside air cylinder holder.

The above is an explanation on example of this application. There is a need to understand that the specific implementation modes above are not a restraint over this application, and any transformations or modifications made by technicians in this field within the scope of the claim will not have an impact on the contents of this application.

1. The positive-pressure air respirator carrying tool for the air cylinder holder with a built-in decompressor has a backboard main body, a decompressor and an air cylinder holder. The backboard's main body is equipped with an air cylinder holder, which is used to fix the air cylinder, and the decompressor is installed within the air cylinder holder.

2. As described by claim 1, the carrying tool above has following features: air cylinder holder is utilized along with air cylinder belt and buckle. The air cylinder will be locked by air cylinder belt and buckle after being installed on air cylinder holder.

3. As described by claim 1, the carrying tool has a compressed air respirator with a self-contained open circuit or a high-positive fire-fighting respirator.

4. As described by claim 2, the carrying tool has a compressed air respirator with a self-contained open circuit or a high-positive fire-fighting respirator.
